(19) United States
(12) Patent Application Publication
(10) Pub. No.: US 2026/0246719 A1
(43) Pub. Date: Aug. 20, 2026

(54) MODEL PREDICTION PROCESSING METHOD AND APPARATUS, TERMINAL, AND NETWORK-SIDE DEVICE

(71) Applicant: VIVO MOBILE COMMUNICATION CO., LTD., Guangdong (CN)

(72) Inventor: Erhao SONG, Guangdong (CN)

(21) Appl. No.: 19/640,803

(22) Filed: Apr. 7, 2026

Related U.S. Application Data
(63) Continuation of application No. PCT/CN2024/123298, filed on Oct. 8, 2024.

(30) Foreign Application Priority Data
Oct. 9, 2023 (CN) 202311299595.0

(51) Int. Cl. H04L 41/16; H04W 76/18

(52) U.S. Cl. CPC H04L 41/16; H04W 76/18

(57) ABSTRACT

This application discloses a model prediction processing method and apparatus, a terminal, and a network-side device. The method provided in embodiments of this application includes: A terminal receives configuration information from a network-side device; and the terminal obtains, based on a target AI model, a prediction result including a first output or a second output. The first output includes at least one of the following: an indication of whether a target timer will expire; a moment at which the target timer expires; predicted signal quality of a serving cell; predicted signal quality of a neighboring cell; predicted signal quality of a target cell; an indication of whether a first target behavior will occur; and a moment at which the first target behavior occurs.

### CROSS-REFERENCE TO RELATED APPLICATIONS

This application is a continuation application of PCT International Application No. PCT/CN 2024/123298 filed on Oct. 8, 2024, which claims priority to Chinese Patent Application No. 202311299595.0 filed in China on Oct. 9, 2023, which is incorporated herein by reference in its entirety.

### TECHNICAL FIELD

This application relates to the field of communication technologies, and specifically, relates to a model prediction processing method and apparatus, a terminal, and a network-side device.

### BACKGROUND

With the development of communications technologies, a timer and a counter are usually set in a communications system to control processes such as radio resource control (RRC) connection establishment, resume, and re-establishment, as well as mobility management and beam management. However, currently, a related process usually needs to be performed only when the timer expires or the counter reaches a maximum counting value, which causes a high execution latency in the related process. For example, for a timer T304, a terminal continuously attempts to access a target cell before the timer expires. Consequently, a data interruption time is excessively long, and unnecessary power consumption of the terminal is caused. Therefore, the related technology has a problem of poor communication performance due to an excessively long running time of a timer or a counter.

### SUMMARY

Embodiments of this application provide a model prediction processing method and apparatus, a terminal, and a network-side device.

According to a first aspect, a model prediction processing method is provided, including:
a terminal receives configuration information from a network-side device, where the configuration information is used for configuring a target artificial intelligence AI model; and
the terminal performs model inference based on the target AI model, to obtain a prediction result, where the prediction result includes a first output or a second output of the target AI model;
the first output includes at least one of the following: an indication of whether a target timer will expire; a moment at which the target timer expires; predicted signal quality of a serving cell at a future moment; predicted signal quality of a neighboring cell at the future moment; predicted signal quality of a target cell at the future moment; an indication of whether a first target behavior will occur; and a moment at which the first target behavior occurs;
the second output includes at least one of the following: an indication of whether a target counter will reach a maximum counting value; a moment at which the target counter reaches the maximum counting value; predicted signal quality of a serving cell at a future moment; predicted signal quality of a neighboring cell at the future moment; predicted signal quality of a target cell at the future moment; an indication of whether a second target behavior will occur; and a moment at which the second target behavior occurs; and
the first target behavior refers to a behavior corresponding to the target timer expiring, and the second target behavior refers to a behavior corresponding to the target counter reaching the maximum counting value.

According to a second aspect, a model prediction processing method is provided, including:
a network-side device sends configuration information to a terminal, where the configuration information is used for configuring a target artificial intelligence AI model, the target AI model is configured to perform model inference to obtain a prediction result, and the prediction result includes a first output or a second output of the target AI model;
the first output includes at least one of the following: an indication of whether a target timer will expire; a moment at which the target timer expires; predicted signal quality of a serving cell at a future moment; predicted signal quality of a neighboring cell at the future moment; predicted signal quality of a target cell at the future moment; an indication of whether a first target behavior will occur; and a moment at which the first target behavior occurs;
the second output includes at least one of the following: an indication of whether a target counter will reach a maximum counting value; a moment at which the target counter reaches the maximum counting value; predicted signal quality of a serving cell at a future moment; predicted signal quality of a neighboring cell at the future moment; predicted signal quality of a target cell at the future moment; an indication of whether a second target behavior will occur; and a moment at which the second target behavior occurs; and
the first target behavior refers to a behavior corresponding to the target timer expiring, and the second target behavior refers to a behavior corresponding to the target counter reaching the maximum counting value.

According to a third aspect, a model prediction processing apparatus is provided, including:
a first receiving module, configured to receive configuration information from a network-side device, where the configuration information is used for configuring a target artificial intelligence AI model; and
an inference module, configured to perform model inference based on the target AI model, to obtain a prediction result, where the prediction result includes a first output or a second output of the target AI model;
the first output includes at least one of the following: an indication of whether a target timer will expire; a moment at which the target timer expires; predicted signal quality of a serving cell at a future moment; predicted signal quality of a neighboring cell at the future moment; predicted signal quality of a target cell at the future moment; an indication of whether a first target behavior will occur; and a moment at which the first target behavior occurs;
the second output includes at least one of the following: an indication of whether a target counter will reach a maximum counting value; a moment at which the target counter reaches the maximum counting value; predicted signal quality of a serving cell at a future moment; predicted signal quality of a neighboring cell at the future moment; predicted signal quality of a target cell at the future moment; an indication of whether a second target behavior will occur; and a moment at which the second target behavior occurs; and
the first target behavior refers to a behavior corresponding to the target timer expiring, and the second target behavior refers to a behavior corresponding to the target counter reaching the maximum counting value.

According to a fourth aspect, a model prediction processing apparatus is provided, including:
a first sending module, configured to send configuration information to a terminal, where the configuration information is used for configuring a target artificial intelligence AI model, the target AI model is configured to perform model inference to obtain a prediction result, and the prediction result includes a first output or a second output of the target AI model;
the first output includes at least one of the following: an indication of whether a target timer will expire; a moment at which the target timer expires; predicted signal quality of a serving cell at a future moment; predicted signal quality of a neighboring cell at the future moment; predicted signal quality of a target cell at the future moment; an indication of whether a first target behavior will occur; and a moment at which the first target behavior occurs;
the second output includes at least one of the following: an indication of whether a target counter will reach a maximum counting value; a moment at which the target counter reaches the maximum counting value; predicted signal quality of a serving cell at a future moment; predicted signal quality of a neighboring cell at the future moment; predicted signal quality of a target cell at the future moment; an indication of whether a second target behavior will occur; and a moment at which the second target behavior occurs; and
the first target behavior refers to a behavior corresponding to the target timer expiring, and the second target behavior refers to a behavior corresponding to the target counter reaching the maximum counting value.

According to a fifth aspect, a terminal is provided. The terminal includes a processor and a memory, where the memory stores a program or instructions runnable on the processor, and the program or instructions, when executed by the processor, implement the steps of the method according to the first aspect.

According to a sixth aspect, a terminal is provided, including a processor and a communication interface, where the communication interface is configured to receive configuration information from a network-side device, and the configuration information is used for configuring a target artificial intelligence AI model;
the processor is configured to perform model inference based on the target AI model, to obtain a prediction result, and the prediction result includes a first output or a second output of the target AI model;
the first output includes at least one of the following: an indication of whether a target timer will expire; a moment at which the target timer expires; predicted signal quality of a serving cell at a future moment; predicted signal quality of a neighboring cell at the future moment; predicted signal quality of a target cell at the future moment; an indication of whether a first target behavior will occur; and a moment at which the first target behavior occurs;
the second output includes at least one of the following: an indication of whether a target counter will reach a maximum counting value; a moment at which the target counter reaches the maximum counting value; predicted signal quality of a serving cell at a future moment; predicted signal quality of a neighboring cell at the future moment; predicted signal quality of a target cell at the future moment; an indication of whether a second target behavior will occur; and a moment at which the second target behavior occurs; and
the first target behavior refers to a behavior corresponding to the target timer expiring, and the second target behavior refers to a behavior corresponding to the target counter reaching the maximum counting value.

According to a seventh aspect, a network-side device is provided. The network-side device includes a processor and a memory, where the memory stores a program or instructions runnable on the processor, and the program or instructions, when executed by the processor, implement the steps of the method according to the second aspect.

According to an eighth aspect, a network-side device is provided, including a processor and a communication interface, where the communication interface is configured to send configuration information to a terminal, and the configuration information is used for configuring a target artificial intelligence AI model, the target AI model is configured to perform model inference to obtain a prediction result, and the prediction result includes a first output or a second output of the target AI model;
the first output includes at least one of the following: an indication of whether a target timer will expire; a moment at which the target timer expires; predicted signal quality of a serving cell at a future moment; predicted signal quality of a neighboring cell at the future moment; predicted signal quality of a target cell at the future moment; an indication of whether a first target behavior will occur; and a moment at which the first target behavior occurs;
the second output includes at least one of the following: an indication of whether a target counter will reach a maximum counting value; a moment at which the target counter reaches the maximum counting value; predicted signal quality of a serving cell at a future moment; predicted signal quality of a neighboring cell at the future moment; predicted signal quality of a target cell at the future moment; an indication of whether a second target behavior will occur; and a moment at which the second target behavior occurs; and
the first target behavior refers to a behavior corresponding to the target timer expiring, and the second target behavior refers to a behavior corresponding to the target counter reaching the maximum counting value.

According to a ninth aspect, a readable storage medium is provided. The readable storage medium stores a program or instructions, and the program or instructions, when executed by a processor, implement steps of the method according to the first aspect, or implement steps of the method according to the second aspect.

According to a tenth aspect, a wireless communication system is provided, including a terminal and a network-side device, where the terminal may be configured to perform the steps of the method according to the first aspect, and the network-side device may be configured to perform the steps of the method according to the second aspect.

According to an eleventh aspect, a chip is provided. The chip includes a processor and a communication interface, where the communication interface is coupled to the processor, and the processor is configured to run a program or instructions to implement the method according to the first aspect or the method according to the second aspect.

According to a twelfth aspect, a computer program/program product is provided. The computer program/program product is stored in a storage medium. The computer program/program product is executed by at least one processor to implement the method according to the first aspect, or to implement the method according to the second aspect.

### BRIEF DESCRIPTION OF THE DRAWINGS

FIG. 1 is a block diagram of a wireless communication system to which embodiments of this application are applicable.

FIG. 2 is a structural diagram of a neuron in a neural network.

FIG. 3 is a flowchart of a model prediction processing method according to an embodiment of this application.

FIG. 4 is a flowchart of another model prediction processing method according to an embodiment of this application.

FIG. 5 is a structural diagram of a model prediction processing apparatus according to an embodiment of this application.

FIG. 6 is a structural diagram of another model prediction processing apparatus according to an embodiment of this application.

FIG. 7 is a structural diagram of a communication device according to an embodiment of this application.

FIG. 8 is a structural diagram of a terminal according to an embodiment of this application.

FIG. 9 is a structural diagram of a network-side device according to an embodiment of this application.

### DETAILED DESCRIPTION

The terms “first”, “second”, and the like in this application are used to distinguish similar objects, but are not used to describe a specific sequence or order. It should be understood that terms used in this way are interchangeable in appropriate circumstances, so that embodiments of this application can be implemented in other orders than the order illustrated or described herein. In addition, objects distinguished by “first” and “second” are usually objects of one class with a quantity of objects unlimited. For example, a first object can indicate one or more first objects. In addition, “or” in this application indicates at least one of connected objects. For example, “A or B” covers three solutions, to be specific, a solution 1: including A and excluding B; a solution 2: including B and excluding A; and a solution 3: including both A and B. The character “/” generally indicates an “or” relationship between the associated objects.

The term “indication” in this application may be a direct indication (or an explicit indication), or may be an indirect indication (or an implicit indication). The direct indication may be understood as that a sender explicitly notifies a receiver of content such as specific information, an operation that needs to be performed, or a request result in a sent indication. The indirect indication may be understood as that a receiver determines corresponding information based on an indication sent by a sender, or performs determination and determines, based on a determination result, an operation that needs to be performed or a request result.

It should be noted that the technologies described in embodiments of this application are not limited to a long term evolution (LTE)/LTE-advanced (LTE-A) system, and may further be used in another wireless communication system, such as code division multiple access (CDMA), time division multiple access (TDMA), frequency division multiple access (FDMA), orthogonal frequency division multiple access (OFDMA), single-carrier frequency-division multiple access (SC-FDMA) , or another system. The terms “system” and “network” in embodiments of this application are often used interchangeably, and the described technology can be applied to the systems and radio technologies mentioned above, and can further be applied to other systems and radio technologies. The following description describes a new radio (NR) system for illustrative purposes and uses the term NR for much of the following description. However, these technologies may further be used in systems other than the NR system, such as 6^{th} generation (6G) communication systems.

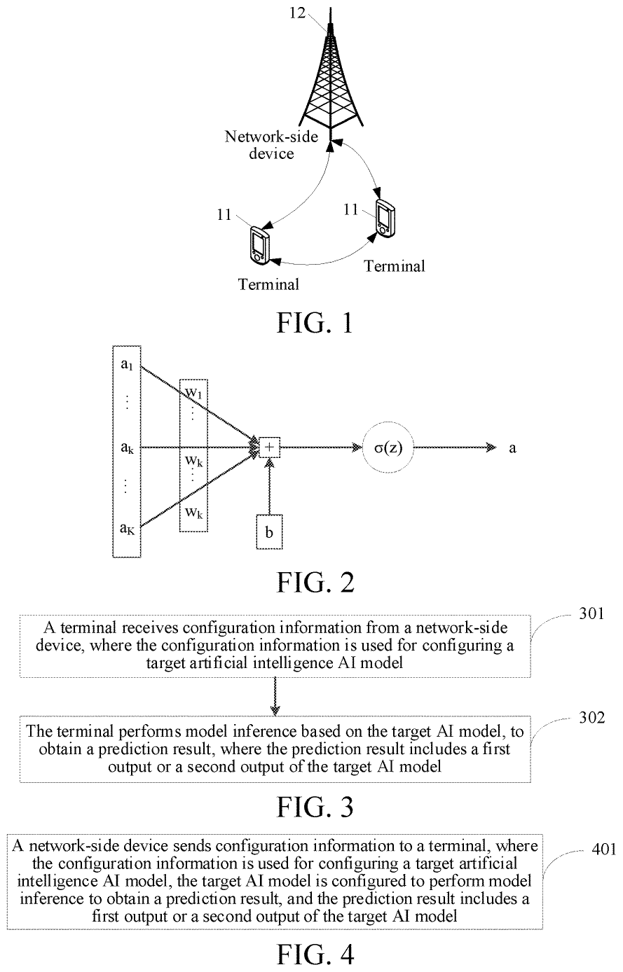

FIG. 1 is a block diagram of a wireless communication system to which embodiments of this application are applicable. The wireless communication system includes a terminal 11 and a network-side device 12. The terminal 11 may be a terminal-side device, such as a mobile phone, a tablet personal computer, a laptop computer, a notebook computer, a personal digital assistant (PDA), a palmtop computer, a netbook, an ultra-mobile personal computer (UMPC), a mobile Internet device (MID), an augmented reality (AR) device, a virtual reality (VR) device, a robot, a wearable device, a flight vehicle, vehicle user equipment (VUE), a ship-borne device, pedestrian user equipment (PUE), a smart home appliance (a home device having a wireless communication function, such as a refrigerator, a television, a washing machine, or furniture), a gaming console, a personal computer (PC), a teller machine, or a self-service machine. The wearable device includes: a smartwatch, a smart bracelet, a smart earphone, smart glasses, smart jewelry (including a smart bangle, a smart chain bracelet, a smart ring, a smart necklace, a smart anklet, a smart anklet chain, and the like), a smart wristband, smart clothing, and the like. The vehicle user equipment may alternatively be referred to as an in-vehicle terminal, an in-vehicle controller, an in-vehicle module, an in-vehicle component, an in-vehicle chip, an in-vehicle unit, or the like. It should be noted that a specific type of the terminal 11 is not limited in embodiments of this application. The network-side device 12 may include an access network device or a core network device. The access network device may alternatively be referred to as a radio access network (RAN) device, a radio access network function, or a radio access network unit. The access network device may include a base station, a wireless local area network (WLAN) access point (AP), a Wireless Fidelity (WiFi) node, or the like. The base station may be referred to as a Node B (NB), an evolved Node B (eNB), the next generation Node B (gNB), a new radio Node B (NR Node B), an access point, a relay base station (RBS), a serving base station (SBS), a base transceiver station (BTS), a radio base station, a radio transceiver, a basic service set (BSS), an extended service set (ESS), a home Node B (HNB), a home evolved Node B, a transmission reception point (TRP), or another suitable term in the field. As long as the same technical effects are achieved, the base station is not limited to a specific technical term. It should be noted that in embodiments of this application, the base station in the NR system is used merely as an example for description, and a specific type of the base station is not limited.

The core network device may include, but is not limited to, at least one of the following: a core network node, a core network function, a mobility management entity (MME), an access and mobility management function (AMF), a session management function (SMF), a user plane function (UPF), a policy control function (PCF), a policy and charging rules function (PCRF), an edge application server discovery function (EASDF), unified data management (UDM), unified data repository (UDR), a home subscriber server (HSS), a centralized network configuration (CNC), a network repository function (NRF), a network exposure function (NEF), a local NEF (L-NEF), a binding support function (BSF), an application function (AF), and the like. It should be noted that in embodiments of this application, the core network device in the NR system is used merely as an example for description, and a specific type of the core network device is not limited.

For ease of understanding, content involved in embodiments of this application is described below.

I. Artificial intelligence.

Currently, artificial intelligence has been widely used in various fields. An artificial intelligence (AI) module (or an AI model) is implemented in a plurality of manners, for example, by using a neural network, a decision tree, a support vector machine, and a Bayes classifier. In this application, a neural network is used as an example for description, but a specific type of the AI module is not limited.

Optionally, the neural network is composed of neurons. FIG. 2 is a diagram of neurons. In the figure, a1, a2, . . . , aK denote inputs, w denotes a weight, namely, a multiplicative coefficient, b denotes a bias, namely, an additive coefficient, and σ(.) denotes an activation function. Common activation functions include Sigmoid, tanh, a rectified linear unit (ReLU), and the like. z=a₁w₁+ . . . +aₖwₖ+ . . . +a_{K}w_{K}+b.

Parameters of the neural network are optimized by using an optimization algorithm.

The optimization algorithm refers to an algorithm capable of minimizing or maximizing an objective function. The objective function may alternatively be referred to as a loss function. The objective function is typically a mathematical combination of model parameters and data. For example, data X and a label Y corresponding to the data are given, and one neural network model f(.) is constructed. Through the model, a predicted output f(x) can be obtained after x is inputted. In addition, a difference (f(x)−Y) between a predicted value and a real value can be calculated, which is referred to as the loss function. The objective of this application is to find proper W, b to minimize the value of the loss function. A smaller loss value indicates that the model is closer to the real situation.

Currently common optimization algorithms are mostly based on an error back propagation (BP) algorithm. A basic idea of the BP algorithm is that a learning process includes two processes: forward propagation of a signal and back propagation of an error. During forward propagation, an input sample is transferred from an input layer to an output layer after being processed by hidden layers. If an actual output of the output layer is inconsistent with an expected output, back propagation of an error is performed. Error back propagation is to transmit an output error layer by layer to the input layer through the hidden layers in a form for back propagation, and allocate the error to all units of the layers, to obtain error signals of the units of the layers. The error signals are used as bases for correcting weights of the units. Such a process of adjusting the weights of the layers that involves signal forward propagation and error back propagation is performed iteratively. A process of continuously adjusting a weight is referred to as a learning and training process of a network. This process is performed until an error outputted by the network is reduced to an acceptable degree, or until learning is performed for a preset quantity of times.

Common optimization algorithms include gradient descent, stochastic gradient descent (SGD), mini-batch gradient descent, momentum, stochastic gradient descent with momentum (Nesterov), adaptive gradient descent (Adagrad), an adaptive learning rate adjustment algorithm (Adadelta), root mean square prop (RMSprop), adaptive moment estimation (Adam), and the like.

During error back propagation, in the optimization algorithms, a derivative or partial derivative of a current neuron is obtained based on an error or a loss obtained by using the loss function, a gradient is obtained with reference to factors such as a learning rate, a previous gradient, the derivative, or the partial derivative, and the gradient is transmitted to a previous layer.

### II. AI Model

In this application, the AI model may be referred to as an AI unit, a machine learning (ML) model, an ML unit, an AI structure, an AI function, an AI feature, a neural network, a neural network function, a neural network function, or the like. Alternatively, the AI model may refer to a processing unit capable of implementing a specific algorithm, formula, processing procedure, capability, and the like related to AI. Alternatively, the AI model may be a processing method, algorithm, function, module, or unit for a specific data set. Alternatively, the AI model may be a processing method, algorithm, function, module, or unit running on hardware related to AI or ML, such as a graphics processing unit (GPU), a neural processing unit (NPU), a tensor processing unit (TPU), or an application specific integrated circuit (ASIC). This is not further limited herein.

Optionally, the specific data set includes at least one of an input and an output of the AI model.

Optionally, an identifier of the AI model may be an AI model identifier, an AI structure identifier, an AI algorithm identifier, an identifier of a specific data set associated with the AI model, an identifier of a specific scenario, environment, channel feature, or device related to AI or ML, or an identifier of a function, feature, capability, or module related to AI or ML. This is not further limited herein.

III. Timer and counter in 5^{th} generation mobile communication technology (5G) NR

In the 5G NR system, a terminal side maintains a plurality of timers and counters configured by a network side, to control processes related to mobility, such as RRC connection establishment, re-establishment, and resume, as well as radio link monitoring (RLM), Beam Failure Detection (BFD), and random access during handover.

Specifically, the timer includes:

T300: a timer for UE waiting for RRC connection response;

T301: a timer for UE waiting for an RRC re-establishment process;

T304: a timer for UE random access to SpCell;

T310: a timer for UE monitoring a radio link failure (RLF);

T311: a timer for UE transitioning to an idle state upon detecting RLF;

T312: a timer configured for fast handover failure recovery;

T316: a timer configured for fast master cell group (MCG) link recovery (fast MCG link recovery);

T319: a timer for UE waiting for RRC connection resume response;

Beam failure detection timer (beamFailureDetectionTimer): a timer configured for a beam failure detection procedure; and

Beam failure recovery timer (beamFailureRecoveryTimer): a timer configured for beam failure recovery.

Definitions of timer start and stop and behaviors corresponding timer expiry are provided below.

For T300: a starting condition includes that a terminal sends an RRC connection establishment request message (RRCSetupRequest). A stopping condition includes that the terminal receives an RRC establishment message (RRCSetup) or an RRC connection reject message (RRCReject), or triggers a cell re-selection process, or an upper layer aborts an RRC connection process. A behavior corresponding to T300 expiry includes at least one of the following: UE resets a Media Access Control (MAC) entity; releases a MAC layer configuration; re-establishes radio link control (RLC) entities of all established radio bearers (RB); and notifies an upper layer of an RRC connection failure.

For T301, a starting condition includes that UE sends an RRC re-establishment request message (RRCReestablishmentRequest). A stopping condition includes that the UE receives an RRC re-establishment message (RRCReestabilshment) or an RRC establishment message. A behavior corresponding to T301 expiry includes entering an idle state (RRC_IDLE).

For T304: a starting condition includes that UE receives an RRC re-configuration message carrying reconfiguration with sync or performs conditional configuration. A stopping condition includes successfully completing random access on a corresponding special cell (SpCell). For a secondary cell group (SCG), once the SCG is released, T304 is stopped. A behavior corresponding to T304 expiry includes at least one of the following: for an MCG, initiating an RRC re-establishment procedure for a handover from NR or intra-NR handover. For a handover to NR, an action defined in a source radio access technology (source RAT) protocol is performed. A failure information process is initiated if a dual active protocol stack (DAPS) bearer is configured and a source primary cell (PCell) does not have an RLF. For an SCG, an SCG failure information procedure is initiated to notify a network of a failure of reconfiguration with sync.

For T310: a starting condition includes detecting a physical layer problem of a special cell (SpCell). For example, N310 consecutive out-of-sync indications are received from a bottom layer. A stopping condition includes receiving N311 consecutive in-sync indications of SpCell from the bottom layer; or receives an RRC re-configuration message carrying reconfigurationWithSync. A behavior corresponding to T310 expiry includes at least one of the following: for an MCG, if the application server (ASE) security is not activated, UE enters RRC_IDLE; or if the application server security is activated, the UE initiates an MCG failure information procedure or a connection reestablishment procedure. For an SCG, an SCG failure information procedure is initiated.

For T311: a starting condition includes initiating an RRC connection re-establishment procedure. A stopping condition includes selecting a suitable NR cell. A behavior corresponding to T311 expiry includes entering RRC_IDLE.

For T312: a starting condition includes at least one of the following: if T312 is configured in an MCG: during running of T310, a terminal triggers measurement reporting corresponding to a measurement ID, T312 is configured for the measurement ID, and useT312 is configured as true. If T312 is configured in an SCG and useT312 is configured as true: during running of T310, the terminal triggers measurement reporting corresponding to a measurement ID, and T312 is configured for the measurement ID. A stopping condition includes that N311 consecutive in-sync indications of SpCell are received from a bottom layer, or an RRC reconfiguration message including reconfigurationWithSync is received, or conditional reconfiguration is performed. A behavior corresponding to T312 expiry includes at least one of the following: for T312 in the MCG, an MCG failure information procedure or a connection re-establishment procedure is initiated; and for T312 in the SCG, an SCG failure information procedure is initiated.

For T316: a starting condition includes transmitting an MCGFailureInformation message. A stopping condition includes at least one of the following: receiving RRCRelease; and receiving an RRC re-configuration (RRCReconfiguration) message carrying reconfigurationwithSync for PCell; and receiving a mobility command (MobilityFromNRCommand) from NR or initiating a re-establishment procedure. A behavior corresponding to T316 expiry includes initiating a connection re-establishment procedure.

For T319: a starting condition includes that the timer is started after an RRC resume request or RRCResumeRequest is transmitted, and a resume procedure is not initiated for short data transfer (SDT). A stopping condition includes receiving an RRC resume, RRC setup, RRC release, RRC release with suspend configuration (RRC Release with Suspend Config), or RRC reject message; and cell re-selection. A behavior corresponding to T319 expiry includes entering RRC_IDLE.

For beamFailureDetectionTimer: a starting condition includes receiving a beam failure instance (BFI) indication from a bottom layer. A behavior upon expiry includes setting a backward failure indicator counter (BFI_COUNTER) to 0.

For beamFailureRecoveryTimer: a starting condition includes detecting beam failure recovery (BFR). A stopping condition includes successfully completing random access procedure for BFR on SpCell. A behavior upon expiry includes: ceasing to perform BFR using contention free random access (CFRA); continuing to perform contention based random access (CBRA) if preambleTransMax has not reached a maximum quantity of transmissions; and MAC reporting RLF to RRC if random access channel (RACH) still fails after a maximum quantity of retransmissions has been reached.

Specifically, the counter includes:
N310: a counter for controlling a starting moment of T310;
N311: a counter for controlling a stopping moment of T310; and

Beam failure instance counter (BFI_COUNTER): a counter for controlling a triggering moment of beam failure recovery.

Definitions of reset and increment of the counters and behaviors corresponding to reaching a maximum counting value are provided below.

For N310: a resetting condition includes at least one of the following: receiving an “in-sync” indication from a bottom layer; receiving an RRC re-configuration message carrying reconfigurationWithSync; and initiating a connection re-establishment procedure. An increment condition includes receiving “out-of-sync” from the bottom layer when running of T310 is stopped. A behavior performed upon the maximum counting value being reached includes starting the timer T310.

For N311: a resetting condition includes at least one of the following: receiving an “in-sync” indication from a bottom layer; receiving an RRC re-configuration message carrying reconfigurationWithSync; and initiating a connection re-establishment procedure. An increment condition includes receiving “in-sync” from the bottom layer during running of T310. A behavior performed upon the maximum counting value is reached includes stopping the timer T310.

For BFI_COUNTER: a resetting condition includes at least one of the following: expiry of beamFailureDetectionTimer; and successful completion of a random access procedure for BFR on SpCell. An increment condition includes receiving a beam failure instance indication from a bottom layer. When the maximum counting value (beamFailureInstanceMaxCount) is reached, BFR is triggered.

A model prediction processing method provided in embodiments of this application is described in detail below through some embodiments and application scenarios thereof with reference to the accompanying drawings.

Refer to FIG. 3. Embodiments of this application provide a model prediction processing method. As shown in FIG. 3, the model prediction processing method includes:
Step 301: A terminal receives configuration information from a network-side device, where the configuration information is used for configuring a target artificial intelligence AI model.
Step 302: The terminal performs model inference based on the target AI model, to obtain a prediction result, where the prediction result includes a first output or a second output of the target AI model.

The first output includes at least one of the following: an indication of whether a target timer will expire; a moment at which the target timer expires; predicted signal quality of a serving cell at a future moment; predicted signal quality of a neighboring cell at the future moment; predicted signal quality of a target cell at the future moment; an indication of whether a first target behavior will occur; and a moment at which the first target behavior occurs.

The second output includes at least one of the following: an indication of whether a target counter will reach a maximum counting value; a moment at which the target counter reaches the maximum counting value; predicted signal quality of a serving cell at a future moment; predicted signal quality of a neighboring cell at the future moment; predicted signal quality of a target cell at the future moment; an indication of whether a second target behavior will occur; and a moment at which the second target behavior occurs.

The first target behavior refers to a behavior corresponding to the target timer expiring, and the second target behavior refers to a behavior corresponding to the target counter reaching the maximum counting value.

In embodiments of this application, the prediction result is used for determining whether the first target behavior or the second target behavior will occur. The prediction result is obtained through the target AI model, so that whether the first target behavior occurs can be determined before the target timer expires, or whether the second target behavior occurs can be determined before the target counter reaches the maximum counting value. In this way, an operation corresponding to the first target behavior or an operation corresponding to the second target behavior can be performed in advance based on the prediction result. Alternatively, the prediction result is reported to the network-side device, so that the terminal can perform the operation corresponding to the first target behavior or the operation corresponding to the second target behavior in advance. In this way, problems such as deterioration of service quality of the terminal, data interruption, and waste of power consumption caused by excessively long running time of the timer or the counter can be avoided. Therefore, embodiments of this application improves communication performance.

Optionally, in a case that the first output includes at least one of an indication that the target timer will expire, the moment at which the target timer expires, an indication that the first target behavior will occur, and the moment at which the first target behavior occurs, it may be determined, based on the first output, that the first target behavior will occur.

Optionally, in a case that the first output includes at least one of the predicted signal quality of the serving cell at the future moment, the predicted signal quality of the neighboring cell at the future moment, and the predicted signal quality of the target cell at the future moment, whether the first target behavior occurs may be determined based on strength of the predicted signal quality. For example, when the predicted signal quality of the serving cell at the future moment is low, or the predicted signal quality of the neighboring cell at the future moment is high, it may be considered that the first target behavior will occur.

Optionally, in a case that the second output includes at least one of an indication that the target counter will reach the maximum counting value, the moment at which the target counter reaches the maximum counting value, an indication that the second target behavior will occur, and the moment at which the second target behavior occurs, it may be determined, based on the second output, that the second target behavior will occur.

Optionally, in a case that the second output includes at least one of the predicted signal quality of the serving cell at the future moment, the predicted signal quality of the neighboring cell at the future moment, and the predicted signal quality of the target cell at the future moment, whether the second target behavior occurs may be determined based on strength of the predicted signal quality. For example, when the predicted signal quality of the serving cell at the future moment is low, or the predicted signal quality of the neighboring cell at the future moment is high, it may be considered that the second target behavior will occur.

In some embodiments, the signal quality includes a reference signal received power (RSRP), reference signal received quality (RSRQ), a signal to interference plus noise ratio (SINR), and a received signal strength indication (RSSI) of a cell or a beam within a cell.

It should be noted that, the moment at which the target timer expires may be specifically represented by a first time interval. The first time interval may be understood as an interval between the moment at which the target timer expires and a starting moment of the target timer or a starting moment of model inference.

The moment at which the target counter reaches the maximum counting value may be specifically represented by a second time interval. The second time interval may be understood as an interval between the moment at which the target counter reaches the maximum counting value and a moment at which the target counter changes from 0 to 1 or a starting moment of model inference.

Optionally, the indication of whether the target timer will expire may be represented by one bit. For example, if a bit value of 0 indicates that expiry will occur, a bit value of 1 indicates that expiry will not occur. Alternatively, on the contrary, the bit value of 1 indicates that expiry will occur, and the bit value of 0 indicates that expiry will not occur.

Optionally, the indication of whether the target counter will reach the maximum counting value may be represented by one bit. For example, if a bit value of 0 indicates that the maximum counting value will be reached, and a bit value of 1 indicates that the maximum counting value will not be reached. Alternatively, on the contrary, the bit value of 1 indicates that the maximum counting value will be reached, and 0 indicates that the maximum counting value will not be reached.

In embodiments of this application, the terminal receives the configuration information from the network-side device, where the configuration information is used for configuring the target artificial intelligence AI model. The terminal performs model inference based on the target AI model, to obtain the prediction result, where the prediction result includes the first output or the second output of the target AI model. The first output includes at least one of the following: the indication of whether the target timer will expire; the moment at which the target timer expires; the predicted signal quality of the serving cell at the future moment; the predicted signal quality of the neighboring cell at the future moment; the predicted signal quality of the target cell at the future moment; the indication of whether the first target behavior will occur; and the moment at which the first target behavior occurs. The second output includes at least one of the following: the indication of whether the target counter reaches the maximum counting value; the moment at which the target counter will reach the maximum counting value; the predicted signal quality of the serving cell at the future moment; the predicted signal quality of the neighboring cell at the future moment; the predicted signal quality of the target cell at the future moment; the indication of whether the second target behavior will occur; and the moment at which the second target behavior occurs. The first target behavior refers to the behavior corresponding to the target timer expiring, and the second target behavior refers to the behavior corresponding to the target counter reaching the maximum counting value. In this way, the terminal can determine whether the first target behavior occurs before the target timer expires or determine whether the second target behavior occurs before the target counter reaches the maximum counting value, so that the terminal can perform, based on the prediction result, an operation corresponding to the first target behavior or an operation corresponding to the second target behavior in advance. Alternatively, the prediction result is reported to the network-side device, so that the terminal can perform the operation corresponding to the first target behavior or the operation corresponding to the second target behavior in advance. In this way, problems such as deterioration of service quality of the terminal, data interruption, and waste of power consumption caused by excessively long running time of the timer or the counter can be avoided. Therefore, embodiments of this application improves communication performance.

Optionally, after the terminal performs model inference based on the target AI model, to obtain the prediction result, the method further includes at least one of the following:

The terminal performs an operation corresponding to a target behavior in a case that the prediction result is a first target result, where the target behavior includes the first target behavior or the second target behavior, and the first target result is that the first output indicates that the first target behavior will occur or the second output indicates that the second target behavior will occur; and
the terminal continues to run the target timer or the target counter in a case that the prediction result is a second target result, where the second target result is that the first output indicates that the first target behavior will not occur or the second output indicates that the second target behavior will not occur.

In embodiments of this application, the first target result includes at least one of the following:
an indication that the target timer will expire or an indication that the target counter will reach the maximum counting value;
an indication that the first target behavior will occur or an indication that the second target behavior will occur; and
a moment at which the first target behavior occurs or a moment at which the second target behavior occurs.

Optionally, the second target result includes at least one of the following:
an indication that the target timer will not expire or an indication that the target counter will not reach the maximum counting value; and
an indication that the first target behavior will not occur or an indication that the second target behavior will not occur.

Optionally, the first target result may further include at least one of the following: the predicted signal quality of the serving cell at the future moment is less than a first threshold, the predicted signal quality of the neighboring cell at the future moment is higher than a second threshold, and the predicted signal quality of the target cell at the future moment is higher than the third threshold.

Optionally, the second target result may further include at least one of the following: the predicted signal quality of the serving cell at the future moment is higher than the first threshold, the predicted signal quality of the neighboring cell at the future moment is lower than the second threshold, or the predicted signal quality of the target cell at the future moment is lower than the third threshold.

Optionally, that the terminal performs the operation corresponding to the target behavior may be understood as or replaced with that the terminal performs the operation corresponding to the target behavior in advance, so that the terminal performs the operation corresponding to the first target behavior before the target timer expires, and performs the operation corresponding to the second target behavior before the target counter reaches the maximum counting value. In this way, when the prediction result is the first target result, the terminal may determine, based on the first target result, that the target behavior will occur, and perform the operation corresponding to the target behavior in advance. Therefore, problems such as deterioration of service quality of the terminal, data interruption, and waste of power consumption caused by excessively long running time of the timer or the counter can be avoided.

Optionally, at least one of the first target behavior and the second target behavior includes at least one of the following: a radio link failure; a beam failure; and a handover failure.

Optionally, after the terminal performs model inference based on the target AI model, to obtain the prediction result, the method further includes:

The terminal reports the prediction result to the network-side device.

In embodiments of this application, the terminal reports the prediction result to the network-side device, so that the network-side device can trigger, according to the prediction result, the terminal to perform the operation corresponding to the target behavior. For example, the network-side device triggers the terminal to perform cell handover, so as to avoid data interruption caused by poor signal quality of the serving cell.

Optionally, that the terminal performs model inference based on the target AI model, to obtain the prediction result includes:

The terminal performs model inference based on the target AI model at a target moment, to obtain the prediction result.

The target moment satisfies at least one of the following:
the target moment is a moment at which the target timer is started;
the target moment is located after the moment at which the target timer is started, and the target moment is separated from the moment at which the target timer is started by first preset duration;
the target moment is a moment at which the target counter changes from 0 to 1; and
the target moment is located after the moment at which the target counter changes from 0 to 1, and the target moment is separated from the moment at which the target counter changes from 0 to 1 by second preset duration.

In embodiments of this application, the moment at which the target counter changes from 0 to 1 may be understood as a moment at which the target counter starts to count. Specifically, the moment at which the target counter changes from 0 to 1 may be understood as a time point at which the target counter changes from 0 to 1, or a time unit corresponding to the time point. The time unit is a second, a millisecond, a frame, a sub-frame, a slot, or a symbol.

The target moment at which AI model inference is performed is determined based on the moment at which the target timer is started or the moment at which the target counter changes from 0 to 1, thereby improving timeliness of model inference, and ensuring that the terminal can obtain an effective prediction result in time.

Optionally, that the terminal performs model inference based on the target AI model, to obtain the prediction result includes:

The terminal performs model inference on the target AI model based on a first input or a second input, to obtain the prediction result.

The first input includes at least one of the following: signal quality of the serving cell at a historical moment before the target timer is started; signal quality of the neighboring cell at the historical moment before the target timer is started; signal quality of the target cell at the historical moment before the target timer is started; signal quality of the serving cell during running of the target timer; signal quality of the neighboring cell during running of the target timer; signal quality of the target cell during running of the target timer; a terminal position at the historical moment before the target timer is started; a terminal velocity at the historical moment before the target timer is started; a terminal direction at the historical moment before the target timer is started; a terminal position during running of the target timer; a terminal velocity during running of the target timer; and a terminal direction during running of the target timer.

The second input includes at least one of the following: signal quality of the serving cell during a period in which a counting value of the target counter is non-zero; signal quality of the neighboring cell during the period in which the counting value of the target counter is non-zero; signal quality of the target cell during the period in which the counting value of the target counter is non-zero; signal quality of the serving cell at a historical moment before the counting value of the target counter is 1; signal quality of the neighboring cell at the historical moment before the counting value of the target counter is 1; signal quality of the target cell at the historical moment before the counting value of the target counter is 1; a terminal position during the period in which the counting value of the target counter is non-zero; a terminal velocity during the period in which the counting value of the target counter is non-zero; a terminal direction during the period in which the counting value of the target counter is non-zero; a terminal position at the historical moment before the counting value of the target counter is 1; a terminal velocity at the historical moment before the counting value of the target counter is 1; and a terminal direction at the historical moment before the counting value of the target counter is 1.

Optionally, the method further includes:

The terminal receives target indication information from the network-side device, where the target indication information indicates a name of a first object to which the target AI model is applicable or an identifier associated with the first object, and the first object is the target timer or the target counter.

In embodiments of this application, the network-side device may include a first network node and a second network node. The first network node refers to a network node receiving data reported by the terminal. The second network node may be understood as a node configured to perform model training. The terminal may receive the target indication information from the second network node.

Optionally, the first network node may be a radio access network (RAN) node, an operation administration and maintenance (OAM) node, a server, or a core network node (such as a network data analytics function (NWDAF)).

Optionally, the second network node may be a RAN node, an OAM node, a server, or a core network node.

It should be understood that the first network node and the second network node may be the same network node or different network nodes.

It should be noted that the target timer may be T300, T301, T304, T310, T311, T312, T316, T319, a beam failure detection timer, a beam failure recovery timer, or a timer in a 5G NR system or another communication system or communication standard. When the target timer is T310, the first target behavior may be a radio link failure. When the target timer is T304, the first target behavior may be a handover failure. When the target timer is a beam failure detection timer, the first target behavior may be a beam failure. For a specific behavior of a first target behavior corresponding to another timer, refer to the related technology. Details are not described herein again. The target counter may be N310, N311, BFI_COUNTER, or a counter in a 5G NR system or another communication system or communication standard. When the target counter is N310, the second target behavior may be starting T310 or a related behavior after T310 is started, such as a radio link failure. For a specific behavior of a second target behavior corresponding to another counter, refer to the related technology. Details are not described herein again.

Optionally, before the terminal performs model inference based on the target AI model, to obtain the prediction result, the method further includes:

The terminal receives first signaling from the network-side device, where the first signaling indicates at least one of the following:
starting, resuming, or activating an AI model function of the target timer;
starting, resuming, or activating an AI model corresponding to the target timer;
starting, resuming, or activating an AI model function of the target counter;
starting, resuming, or activating an AI model corresponding to the target counter;
starting, resuming, or activating an AI model function of the first target behavior;
starting, resuming, or activating an AI model corresponding to the first target behavior;
starting, resuming, or activating an AI model function of the second target behavior; and
starting, resuming, or activating an AI model corresponding to the second target behavior.

In embodiments of this application, the AI model function may be understood as or replaced with a prediction function. Because the network-side device activates the AI model function or the AI model via the first signaling, the network-side device can determine, based on an actual situation, whether to start the AI model inference to perform prediction. In this way, prediction accuracy of the target AI model can be improved.

Optionally, the first signaling includes at least one of the following:
an identifier of an AI model function;
an identifier of an AI model;
a name of the target timer;
an identifier of the target timer;
a name of the target counter;
an identifier of the target counter;
an identifier of the first target behavior; and
an identifier of the second target behavior.

Optionally, before the terminal receives the first signaling from the network-side device, the method further includes:

The terminal reports capability information to the network-side device, where the capability information includes at least one of the following:
whether an AI model function of a timer is available, or whether an AI model corresponding to the timer is available;
whether an AI model function of a counter is available, or whether an AI model corresponding to the counter is available;
whether an AI model function of a first behavior is available, or whether an AI model corresponding to the first behavior is available, where the first behavior refers to a behavior corresponding to the timer expiring; and
whether an AI model function of a second behavior is available, or whether an AI model corresponding to a second behavior is available, where the second behavior refers to a behavior corresponding to the counter reaching a maximum counting value.

Optionally, the method further includes:

The terminal receives second signaling from the network-side device, where the second signaling indicates at least one of the following: stopping, suspending, or deactivating an AI model function of a second object; stopping, suspending, or deactivating an AI model corresponding to the second object; stopping, suspending, or deactivating the AI model function of the first target behavior, stopping, suspending, or deactivating the AI model corresponding to the first target behavior; stopping, suspending, or deactivating the AI model function of the second target behavior, and stopping, suspending, or deactivating the AI model corresponding to the second target behavior; and
the terminal determines, based on the second signaling, to stop inference of the AI model corresponding to the second object.

The second object includes at least one of the target timer and the target counter.

Optionally, the method further includes:

The terminal collects target information, where the target information is used for performing model training.

The target information includes at least one of the following:
first information, where the first information includes at least one of the following: a name of a timer; an identifier associated with the timer; time information corresponding to a starting moment of the timer; time information corresponding to a stopping moment of the timer; time information corresponding to a moment at which the timer expires; signal quality of the serving cell at a historical moment before the timer is started; signal quality of the neighboring cell at the historical moment before the timer is started; signal quality of the target cell at the historical moment before the timer is started; signal quality of the serving cell during running of the timer; signal quality of the neighboring cell during running of the timer; signal quality of the target cell during running of the timer; a terminal position at the historical moment before the timer is started; a terminal velocity at the historical moment before the timer is started; a terminal direction at the historical moment before the timer is started; a terminal position during running of the timer; a terminal velocity during running of the timer; a terminal direction during running of the timer; and a moment at which a first behavior occurs, and the first behavior refers to a behavior corresponding to the timer expiring; and second information, wherein the second information includes at least one of the following: a name of a counter; an identifier associated with the counter; time information corresponding to a moment at which 1 is added to a counting value of the counter; time information corresponding to a moment at which the counting value of the counter is reset to 0; time information corresponding to a moment at which the counter reaches a maximum counting value; signal quality of the serving cell during a period in which the counting value of the counter is non-zero; signal quality of the neighboring cell during the period in which the counting value of the counter is non-zero; signal quality of the target cell during the period in which the counting value of the counter is non-zero; signal quality of the serving cell at a historical moment before the counting value of the counter is 1; signal quality of the neighboring cell at the historical moment before the counting value of the counter is 1; signal quality of the target cell at the historical moment before the counting value of the counter is 1; a terminal position during the period in which the counting value of the counter is non-zero; a terminal velocity during the period in which the counting value of the counter is non-zero; a terminal direction during the period in which the counting value of the counter is non-zero; a terminal position at the historical moment before the counting value of the counter is 1; a terminal velocity at the historical moment before the counting value of the counter is 1; a terminal direction at the historical moment before the counting value of the counter is 1; and a moment at which a second behavior occurs, and the second behavior refers to a behavior corresponding to the counter reaching the maximum counting value.

In embodiments of this application, when the network-side device performs model training, the terminal reports the target information to the network-side device after collecting the target information. When the target information reported by the terminal to the network-side device includes signal quality, the target information may further include a time stamp corresponding to the signal quality and a step between a plurality of time stamps corresponding to signal quality. The time stamp or step may include a unit such as year, month, day, hour, minute, second, millisecond, frame, sub-frame, slot, or symbol.

It should be noted that a manner in which the terminal sends the target information to the network-side device may be specified in a protocol or configured by the network-side device. Specifically, the manner in which the terminal sends the target information to the network-side device includes at least one of the following:
periodic reporting;
event-triggered reporting, for example, reporting triggered by timer expiry, timer stop, or timer restart; and
triggered when a data volume threshold configured by a network is reached, for example, triggered when a volume of data collected by the terminal exceeds a threshold.

It should be understood that the target information being used for model training may be understood as: being used for initial training of the model, being used for re-training of the model, or being used for fine tuning of the model.

For better understanding of this application, detailed description will be provided below through some embodiments by using an example in which the network-side device performs training and the terminal side performs inference.

In some embodiments of this application, the method may be applied to T304 prediction, and specifically includes the following steps:

Step 10: The terminal reports target information collected during a plurality of times of running of T304, where the target information includes at least one of the following: a name of T304; an identifier associated with T304; time information corresponding to a starting moment of T304; time information corresponding to a stopping moment of T304; time information corresponding to a moment at which T304 expires; signal quality of the serving cell at N historical moments before T304 is started; signal quality of the neighboring cell at the N historical moments before T304 is started; signal quality of the target cell at the N historical moments before T304 is started; signal quality of the serving cell during running of T304; signal quality of the neighboring cells during running of T304; signal quality of the target cell during running of T304, terminal positions at the N historical moments before T304 is started; terminal velocities at the N historical moments before T304 is started; terminal directions at the N historical moments before T304 is started; a terminal position during running of T304; a terminal velocity during running of T304; a terminal direction during running of T304; and a moment at which a first behavior occurs, and the first behavior refers to a behavior corresponding to T304 expiring.

Step 11: The terminal receives a model that is configured to predict T304 expiry and that is delivered by the network-side device.

An input of the model is at least one of the following: signal quality of the serving cell at a historical moment before T304 is started; signal quality of the neighboring cell at the historical moment before T304 is started; signal quality of the target cell at the historical moment before T304 is started; the signal quality of the serving cell during running of T304; the signal quality of the neighboring cell during running of T304; the signal quality of the target cell during running of T304; a terminal position at the historical moment before T304 is started; a terminal velocity at the historical moment before T304 is started; a terminal direction at the historical moment before T304 is started; the terminal position during running of T304; the terminal velocity during running of the T304; and the terminal direction during running of T304.

An output of the model is at least one of the following: an indication of whether T304 will expire; a moment at which T304 expires; predicted signal quality of the serving cell at N moments in the future; predicted signal quality of the neighboring cell at the N moments in the future; predicted signal quality of the target cell at the N moments in the future; the indication of whether the first target behavior will occur; and the moment at which the first target behavior occurs.

Step 12: The terminal starts T304 upon receiving an RRC re-configuration message carrying reconfiguration with sync, or performing conditional reconfiguration, or performing L1/L2-triggered mobility (LTM) handover. The terminal performs model inference for the timer T304.

Step 13: The terminal performs the following actions according to an inference result for T304:

Case 1: When it is predicted that T304 will expire, the terminal immediately performs an action that will be performed after T304 expires, for example, initiates an RRC re-establishment procedure for a master cell group (MCG) or an SCG failure information procedure for a secondary cell group (SCG).

Case 2: When it is predicted that T304 will not expire, the terminal continues to run T304 and continuously attempts to access the target cell before T304 expires.

Optionally, for terminal-side training or OTT (Over the Top) server training, step 10 and step 11 are not included. In this case, the network-side device instructs the terminal to start, stop, activate, or deactivate the AI model function or model ID for T304 timer prediction, and the terminal can perform T304 prediction in step 12 and step 13 only when the prediction function is started or activated. The OTT server refers to a service provided by a third party other than an operator.

Optionally, the method may be applied to T310 prediction, and specifically includes the following steps:

Step 20: The terminal reports target information collected during a plurality of times of running of T310, where the target information includes at least one of the following: a name of T310; an identifier associated with T310; time information corresponding to a starting moment of T310; time information corresponding to a stopping moment of T310; time information corresponding to a moment at which T310 expires; signal quality of the serving cell at N historical moments before T310 is started; signal quality of the neighboring cell at the N historical moments before T310 is started; signal quality of the target cell at the N historical moments before T310 is started; signal quality of the serving cell during running of T310; signal quality of the neighboring cell during running of T310; signal quality of the target cell during running of T310, terminal positions at the N historical moments before T310 is started; terminal velocities at the N historical moments before T310 is started; terminal directions at the N historical moments before T310 is stated; a terminal position during running of T310; a terminal velocity during running of T310; a terminal direction during running of T310; and a moment at which a first behavior occurs, and the first behavior refers to a behavior corresponding to T310 expiring.

Step 21: The terminal receives a model that is configured to predict T310 expiry and that is delivered by the network-side device.

An input of the model is at least one of the following: signal quality of the serving cell at a historical moment before T310 is started; signal quality of the neighboring cell at the historical moment before T310 is started; signal quality of the target cell at the historical moment before T310 is started; the signal quality of the serving cell during running of T310; the signal quality of the neighboring cell during running of T310; the signal quality of the target cell during running of T310; a terminal position at the historical moment before T310 is started; a terminal velocity at the historical moment before T310 is started; a terminal direction at the historical moment before T310 is started; the terminal position during running of T310; the terminal velocity during running of T310; and the terminal direction during running of T310.

An output of the model is at least one of the following: an indication of whether T310 will expire; a moment at which T310 expires; predicted signal quality of the serving cell at N moments in the future; predicted signal quality of the neighboring cell at the N moments in the future; predicted signal quality of the target cell at the N moments in the future; the indication of whether the first target behavior will occur; and the moment at which the first target behavior occurs.

Step 22: The terminal receives N310 out-of-sync indications, and starts T310. The terminal performs model inference for the timer T310.

Step 23: The terminal performs the following actions according to an inference result for T310:

Case 1: when it is predicted that T310 will expire, the terminal performs any one of the following:

The terminal immediately performs an action that will be performed after T310 expires. For example, for an MCG, if an application server (AS) security is not activated, the terminal enters an RRC_IDLE state; or the application server security is activated, the terminal initiates an MCG failure information procedure or a connection re-establishment procedure. For an SCG, the terminal initiates an SCG failure information procedure.

The terminal reports a prediction result to a network, where the reported prediction result includes an output result of a model; and the terminal continues to run T310 according to a procedure in the related technology.

The terminal reports the prediction result to the network, and immediately performs the action after T310 expires.

Case 2: When it is predicted that T310 will not expire, the terminal continues to run T310, and stops T310 after receiving N311 consecutive In-Sync indications.

Optionally, for terminal-side training or OTT server straining, step 20 and step 21 are not provided. In this case, the network-side device instructs the terminal to start, stop, activate, or deactivate an AI model function or a model ID for T310 timer prediction, and the terminal can perform T310 prediction in step 22 and step 23 only when the prediction function is started or activated.

Refer to FIG. 4. Embodiments of this application further provide a model prediction processing method. As shown in FIG. 4, the model prediction processing method includes:

Step 401: A network-side device sends configuration information to a terminal, where the configuration information is used for configuring a target artificial intelligence AI model, the target AI model is configured to perform model inference to obtain a prediction result, and the prediction result includes a first output or a second output of the target AI model.

The first output includes at least one of the following: an indication of whether a target timer will expire; a moment at which the target timer expires; predicted signal quality of a serving cell at a future moment; predicted signal quality of a neighboring cell at the future moment; predicted signal quality of a target cell at the future moment; an indication of whether a first target behavior will occur; and a moment at which the first target behavior occurs.

The second output includes at least one of the following: an indication of whether a target counter will reach a maximum counting value; a moment at which the target counter reaches the maximum counting value; predicted signal quality of a serving cell at a future moment; predicted signal quality of a neighboring cell at the future moment; predicted signal quality of a target cell at the future moment; an indication of whether a second target behavior will occur; and a moment at which the second target behavior occurs.

The first target behavior refers to a behavior corresponding to the target timer expiring, and the second target behavior refers to a behavior corresponding to the target counter reaching the maximum counting value.

Optionally, at least one of the first target behavior and the second target behavior includes at least one of the following: a radio link failure; a beam failure; and a handover failure.

Optionally, after the network-side device sends the configuration information to the terminal, the method further includes:

The network-side device receives the prediction result from the terminal.

Optionally, an input of the target AI model includes a first input or a second input.

The first input includes at least one of the following: signal quality of the serving cell at a historical moment before the target timer is started; signal quality of the neighboring cell at the historical moment before the target timer is started; signal quality of the target cell at the historical moment before the target timer is started; signal quality of the serving cell during running of the target timer; signal quality of the neighboring cell during running of the target timer; signal quality of the target cell during running of the target timer; a terminal position at the historical moment before the target timer is started; a terminal velocity at the historical moment before the target timer is started; a terminal direction at the historical moment before the target timer is started; a terminal position during running of the target timer; a terminal velocity during running of the target timer; and a terminal direction during running of the target timer.

The second input includes at least one of the following: signal quality of the serving cell during a period in which a counting value of the target counter is non-zero; signal quality of the neighboring cell during the period in which the counting value of the target counter is non-zero; signal quality of the target cell during the period in which the counting value of the target counter is non-zero; signal quality of the serving cell at a historical moment before the counting value of the target counter is 1; signal quality of the neighboring cell at the historical moment before the counting value of the target counter is 1; signal quality of the target cell at the historical moment before the counting value of the target counter is 1; a terminal position during the period in which the counting value of the target counter is non-zero; a terminal velocity during the period in which the counting value of the target counter is non-zero; a terminal direction during the period in which the counting value of the target counter is non-zero; a terminal position at the historical moment before the counting value of the target counter is 1; a terminal velocity at the historical moment before the counting value of the target counter is 1; and a terminal direction at the historical moment before the counting value of the target counter is 1.

Optionally, the method further includes:

The network-side device sends target indication information to the terminal, where the target indication information indicates a name of a first object to which the target AI model is applicable or an identifier associated with the first object, and the first object is the target timer or the target counter.

Optionally, after the network-side device sends the configuration information to the terminal, the method further includes:

The network-side device sends first signaling to the terminal, where the first signaling indicates at least one of the following:
starting, resuming, or activating an AI model function of the target timer;
starting, resuming, or activating an AI model corresponding to the target timer;
starting, resuming, or activating an AI model function of the target counter;
starting, resuming, or activating an AI model corresponding to the target counter;
starting, resuming, or activating an AI model function of the first target behavior;
starting, resuming, or activating an AI model corresponding to the first target behavior;
starting, resuming, or activating an AI model function of the second target behavior; and
starting, resuming, or activating an AI model corresponding to the second target behavior.

Optionally, the first signaling includes at least one of the following:
an identifier of an AI model function;
an identifier of an AI model;
a name of the target timer;
an identifier of the target timer;
a name of the target counter;
an identifier of the target counter;
an identifier of the first target behavior; and
an identifier of the second target behavior.

Optionally, before the network-side device sends the first signaling to the terminal, the method further includes:

The network-side device receives capability information from the terminal, where the capability information includes at least one of the following:
whether an AI model function of a timer is available, or whether an AI model corresponding to the timer is available;
whether an AI model function of a counter is available, or whether an AI model corresponding to the counter is available;
whether an AI model function of a first behavior is available, or whether an AI model corresponding to the first behavior is available, where the first behavior refers to a behavior corresponding to the timer expiring; and
whether an AI model function of a second behavior is available, or whether an AI model corresponding to a second behavior is available, where the second behavior refers to a behavior corresponding to the counter reaching a maximum counting value.

Optionally, the method further includes:

The network-side device sends second signaling to the terminal, where the second signaling indicates at least one of the following: stopping, suspending, or deactivating an AI model function of a second object; stopping, suspending, or deactivating an AI model corresponding to the second object; stopping, suspending, or deactivating the AI model function of the first target behavior; stopping, suspending, or deactivating the AI model corresponding to the first target behavior; stopping, suspending, or deactivating the AI model function of the second target behavior; and stopping, suspending, or deactivating the AI model corresponding to the second target behavior.

The second object includes at least one of the target timer and the target counter.

The model prediction processing method provided in embodiments of this application may be performed by a model prediction processing apparatus. In embodiments of this application, the model prediction processing apparatus provided in embodiments of this application is described by using an example in which the model prediction processing method is performed by the model prediction processing apparatus.

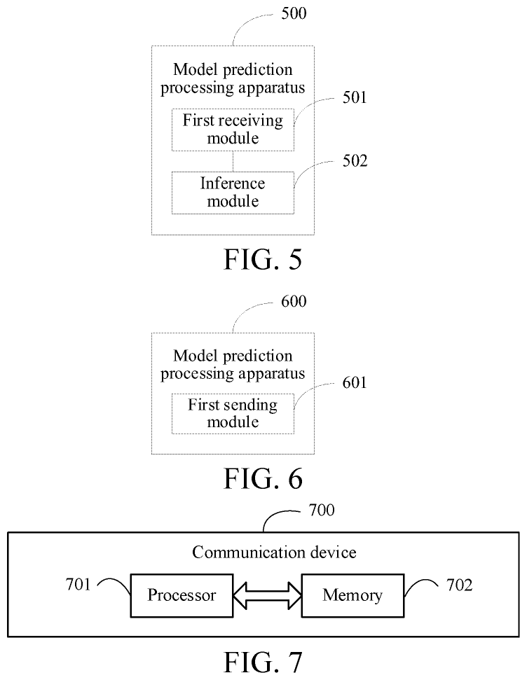

Refer to FIG. 5. Embodiments of this application further provide a model prediction processing apparatus. As shown in FIG. 5, the model prediction processing apparatus 500 includes:
a first receiving module 501, configured to receive configuration information from a network-side device, where the configuration information is used for configuring a target artificial intelligence AI model; and
an inference module 502, configured to perform model inference based on the target AI model, to obtain a prediction result, where the prediction result includes a first output or a second output of the target AI model.

The first output includes at least one of the following: an indication of whether a target timer will expire; a moment at which the target timer expires; predicted signal quality of a serving cell at a future moment; predicted signal quality of a neighboring cell at the future moment; predicted signal quality of a target cell at the future moment; an indication of whether a first target behavior will occur; and a moment at which the first target behavior occurs.

The second output includes at least one of the following: an indication of whether a target counter will reach a maximum counting value; a moment at which the target counter reaches the maximum counting value; predicted signal quality of a serving cell at a future moment; predicted signal quality of a neighboring cell at the future moment; predicted signal quality of a target cell at the future moment; an indication of whether a second target behavior will occur; and a moment at which the second target behavior occurs.

The first target behavior refers to a behavior corresponding to the target timer expiring, and the second target behavior refers to a behavior corresponding to the target counter reaching the maximum counting value.

Optionally, the model prediction processing apparatus 500 further includes: an execution module, configured to perform at least one of the following:
performing an operation corresponding to a target behavior in a case that the prediction result is a first target result, where the target behavior includes the first target behavior or the second target behavior, and the first target result is that the first output indicates that the first target behavior will occur or the second output indicates that the second target behavior will occur; and
continuing to run the target timer or the target counter in a case that the prediction result is a second target result, where the second target result is that the first output indicates that the first target behavior will not occur or the second output indicates that the second target behavior will not occur.

Optionally, the first target result includes at least one of the following:
an indication that the target timer will expire or an indication that the target counter will reach the maximum counting value;
an indication that the first target behavior will occur or an indication that the second target behavior will occur; and
a moment at which the first target behavior occurs or a moment at which the second target behavior occurs.

Optionally, at least one of the first target behavior and the second target behavior includes at least one of the following: a radio link failure; a beam failure; and a handover failure.

Optionally, the model prediction processing apparatus 500 further includes:
a second sending module, configured to report the prediction result to the network-side device.

Optionally, the inference module 502 is specifically configured to perform model inference based on the target AI model at a target moment, to obtain the prediction result.

The target moment satisfies at least one of the following:
the target moment is a moment at which the target timer is started;
the target moment is located after the moment at which the target timer is started, and the target moment is separated from the moment at which the target timer is started by first preset duration;
the target moment is a moment at which the target counter changes from 0 to 1; and
the target moment is located after the moment at which the target counter changes from 0 to 1, and the target moment is separated from the moment at which the target counter changes from 0 to 1 by second preset duration.

Optionally, the inference module 502 is specifically configured to: perform model inference on the target AI model based on a first input or a second input, to obtain a prediction result.

The first input includes at least one of the following: signal quality of the serving cell at a historical moment before the target timer is started; signal quality of the neighboring cell at the historical moment before the target timer is started; signal quality of the target cell at the historical moment before the target timer is started; signal quality of the serving cell during running of the target timer; signal quality of the neighboring cell during running of the target timer; signal quality of the target cell during running of the target timer; a terminal position at the historical moment before the target timer is started; a terminal velocity at the historical moment before the target timer is started; a terminal direction at the historical moment before the target timer is started; a terminal position during running of the target timer; a terminal velocity during running of the target timer; and a terminal direction during running of the target timer.

The second input includes at least one of the following: signal quality of the serving cell during a period in which a counting value of the target counter is non-zero; signal quality of the neighboring cell during the period in which the counting value of the target counter is non-zero; signal quality of the target cell during the period in which the counting value of the target counter is non-zero; signal quality of the serving cell at a historical moment before the counting value of the target counter is 1; signal quality of the neighboring cell at the historical moment before the counting value of the target counter is 1; signal quality of the target cell at the historical moment before the counting value of the target counter is 1; a terminal position during the period in which the counting value of the target counter is non-zero; a terminal velocity during the period in which the counting value of the target counter is non-zero; a terminal direction during the period in which the counting value of the target counter is non-zero; a terminal position at the historical moment before the counting value of the target counter is 1; a terminal velocity at the historical moment before the counting value of the target counter is 1; and a terminal direction at the historical moment before the counting value of the target counter is 1.

Optionally, the first receiving module 501 is further configured to receive target indication information from the network-side device, where the target indication information indicates a name of a first object to which the target AI model is applicable or an identifier associated with the first object, and the first object is the target timer or the target counter.

Optionally, the first receiving module 501 is further configured to receive first signaling from the network-side device, where the first signaling indicates at least one of the following:
starting, resuming, or activating an AI model function of the target timer;
starting, resuming, or activating an AI model corresponding to the target timer;
starting, resuming, or activating an AI model function of the target counter;
starting, resuming, or activating an AI model corresponding to the target counter;
starting, resuming, or activating an AI model function of the first target behavior;
starting, resuming, or activating an AI model corresponding to the first target behavior;
starting, resuming, or activating an AI model function of the second target behavior; and
starting, resuming, or activating an AI model corresponding to the second target behavior.

Optionally, the first signaling includes at least one of the following:
an identifier of an AI model function;
an identifier of an AI model;
a name of the target timer;
an identifier of the target timer;
a name of the target counter;
an identifier of the target counter;
an identifier of the first target behavior; and
an identifier of the second target behavior.

Optionally, the model prediction processing apparatus 500 further includes:
a second sending module, configured to report capability information to the network-side device, where the capability information includes at least one of the following:
whether an AI model function of a timer is available, or whether an AI model corresponding to the timer is available;
whether an AI model function of a counter is available, or whether an AI model corresponding to the counter is available;
whether an AI model function of a first behavior is available, or whether an AI model corresponding to the first behavior is available, where the first behavior refers to a behavior corresponding to the timer expiring; and
whether an AI model function of a second behavior is available, or whether an AI model corresponding to a second behavior is available, where the second behavior refers to a behavior corresponding to the counter reaching a maximum counting value.

Optionally, the first receiving module 501 is further configured to receive second signaling from the network-side device, where the second signaling indicates at least one of the following: stopping, suspending, or deactivating an AI model function of a second object; stopping, suspending, or deactivating an AI model corresponding to the second object; stopping, suspending, or deactivating the AI model function of the first target behavior; stopping, suspending, or deactivating the AI model corresponding to the first target behavior; stopping, suspending, or deactivating the AI model function of the second target behavior; and stopping, suspending, or deactivating the AI model corresponding to the second target behavior.

The inference module is further configured to determine, based on the second signaling, to stop inference of the AI model corresponding to the second object.

The second object includes at least one of the target timer and the target counter.

Optionally, the model prediction processing apparatus 500 further includes: a collection module, configured to collect target information, where the target information is used for performing model training.

The target information includes at least one of the following:
first information, where the first information includes at least one of the following: a name of a timer; an identifier associated with the timer; time information corresponding to a starting moment of the timer; time information corresponding to a stopping moment of the timer; time information corresponding to a moment at which the timer expires; signal quality of the serving cell at a historical moment before the timer is started; signal quality of the neighboring cell at the historical moment before the timer is started; signal quality of the target cell at the historical moment before the timer is started; signal quality of the serving cell during running of the timer; signal quality of the neighboring cell during running of the timer; signal quality of the target cell during running of the timer; a terminal position at the historical moment before the timer is started; a terminal velocity at the historical moment before the timer is started; a terminal direction at the historical moment before the timer is started; a terminal position during running of the timer; a terminal velocity during running of the timer; a terminal direction during running of the timer; and a moment at which a first behavior occurs, and the first behavior refers to a behavior corresponding to the timer expiring; and
second information, wherein the second information includes at least one of the following: a name of a counter; an identifier associated with the counter; time information corresponding to a moment at which 1 is added to a counting value of the counter; time information corresponding to a moment at which the counting value of the counter is reset to 0; time information corresponding to a moment at which the counter reaches a maximum counting value; signal quality of the serving cell during a period in which the counting value of the counter is non-zero; signal quality of the neighboring cell during the period in which the counting value of the counter is non-zero; signal quality of the target cell during the period in which the counting value of the counter is non-zero; signal quality of the serving cell at a historical moment before the counting value of the counter is 1; signal quality of the neighboring cell at the historical moment before the counting value of the counter is 1; signal quality of the target cell at the historical moment before the counting value of the counter is 1; a terminal position during the period in which the counting value of the counter is non-zero; a terminal velocity during the period in which the counting value of the counter is non-zero; a terminal direction during the period in which the counting value of the counter is non-zero; a terminal position at the historical moment before the counting value of the counter is 1; a terminal velocity at the historical moment before the counting value of the counter is 1; a terminal direction at the historical moment before the counting value of the counter is 1; and a moment at which a second behavior occurs, and the second behavior refers to a behavior corresponding to the timer expiring.

Refer to FIG. 6. Embodiments of this application further provide a model prediction processing apparatus. As shown in FIG. 6, the model prediction processing apparatus 600 includes:
a first sending module 601, configured to send configuration information to a terminal, where the configuration information is used for configuring a target artificial intelligence AI model, the target AI model is configured to perform model inference to obtain a prediction result, and the prediction result includes a first output or a second output of the target AI model.

The first output includes at least one of the following: an indication of whether a target timer will expire; a moment at which the target timer expires; predicted signal quality of a serving cell at a future moment; predicted signal quality of a neighboring cell at the future moment; predicted signal quality of a target cell at the future moment; an indication of whether a first target behavior will occur; and a moment at which the first target behavior occurs.

The second output includes at least one of the following: an indication of whether a target counter will reach a maximum counting value; a moment at which the target counter reaches the maximum counting value; predicted signal quality of a serving cell at a future moment; predicted signal quality of a neighboring cell at the future moment; predicted signal quality of a target cell at the future moment; an indication of whether a second target behavior will occur; and a moment at which the second target behavior occurs.

The first target behavior refers to a behavior corresponding to the target timer expiring, and the second target behavior refers to a behavior corresponding to the target counter reaching the maximum counting value.

Optionally, at least one of the first target behavior and the second target behavior includes at least one of the following: a radio link failure; a beam failure; and a handover failure.

Optionally, the model prediction processing apparatus 600 further includes: a second receiving module, configured to receive the prediction result from the terminal.

Optionally, an input of the target AI model includes a first input or a second input.

The first input includes at least one of the following: signal quality of the serving cell at a historical moment before the target timer is started; signal quality of the neighboring cell at the historical moment before the target timer is started; signal quality of the target cell at the historical moment before the target timer is started; signal quality of the serving cell during running of the target timer; signal quality of the neighboring cell during running of the target timer; signal quality of the target cell during running of the target timer; a terminal position at the historical moment before the target timer is started; a terminal velocity at the historical moment before the target timer is started; a terminal direction at the historical moment before the target timer is started; a terminal position during running of the target timer; a terminal velocity during running of the target timer; and a terminal direction during running of the target timer.

The second input includes at least one of the following: signal quality of the serving cell during a period in which a counting value of the target counter is non-zero; signal quality of the neighboring cell during the period in which the counting value of the target counter is non-zero; signal quality of the target cell during the period in which the counting value of the target counter is non-zero; signal quality of the serving cell at a historical moment before the counting value of the target counter is 1; signal quality of the neighboring cell at the historical moment before the counting value of the target counter is 1; signal quality of the target cell at the historical moment before the counting value of the target counter is 1; a terminal position during the period in which the counting value of the target counter is non-zero; a terminal velocity during the period in which the counting value of the target counter is non-zero; a terminal direction during the period in which the counting value of the target counter is non-zero; a terminal position at the historical moment before the counting value of the target counter is 1; a terminal velocity at the historical moment before the counting value of the target counter is 1; and a terminal direction at the historical moment before the counting value of the target counter is 1.

Optionally, the first sending module 601 is further configured to send target indication information to the terminal, where the target indication information indicates a name of a first object to which the target AI model is applicable or an identifier associated with the first object, and the first object is the target timer or the target counter.

Optionally, the first sending module 601 is further configured to send first signaling to the terminal, where the first signaling indicates at least one of the following:
starting, resuming, or activating an AI model function of the target timer;
starting, resuming, or activating an AI model corresponding to the target timer;
starting, resuming, or activating an AI model function of the target counter;
starting, resuming, or activating an AI model corresponding to the target counter;
starting, resuming, or activating an AI model function of the first target behavior;
starting, resuming, or activating an AI model corresponding to the first target behavior;
starting, resuming, or activating an AI model function of the second target behavior; and
starting, resuming, or activating an AI model corresponding to the second target behavior.

Optionally, the first signaling includes at least one of the following:
an identifier of an AI model function;
an identifier of an AI model;
a name of the target timer;
an identifier of the target timer;
a name of the target counter;
an identifier of the target counter;
an identifier of the first target behavior; and
an identifier of the second target behavior.

Optionally, the model prediction processing apparatus 600 further includes:
a second receiving module, configured to receive capability information from the terminal, where the capability information includes at least one of the following:
whether an AI model function of a timer is available, or whether an AI model corresponding to the timer is available;
whether an AI model function of a counter is available, or whether an AI model corresponding to the counter is available;
whether an AI model function of a first behavior is available, or whether an AI model corresponding to the first behavior is available, where the first behavior refers to a behavior corresponding to the timer expiring; and
whether an AI model function of a second behavior is available, or whether an AI model corresponding to a second behavior is available, where the second behavior refers to a behavior corresponding to the counter reaching a maximum counting value.

Optionally, the first sending module 601 is further configured to send second signaling to the terminal, where the second signaling indicates at least one of the following: stopping, suspending, or deactivating an AI model function of a second object; stopping, suspending, or deactivating an AI model corresponding to the second object; stopping, suspending, or deactivating the AI model function of the first target behavior; stopping, suspending, or deactivating the AI model corresponding to the first target behavior; stopping, suspending, or deactivating the AI model function of the second target behavior; and stopping, suspending, or deactivating the AI model corresponding to the second target behavior.

The second object includes at least one of the target timer and the target counter.

The model prediction processing apparatus in embodiments of this application may be an electronic device, such as an electronic device having an operating system, or may be a component, such as an integrated circuit or a chip, in the electronic device. The electronic device may be a terminal, or may be another device other than the terminal. For example, the terminal may include, but is not limited to, types of the terminal 11 listed above. The another device may be a server, a network attached storage (NAS), or the like. This is not specifically limited in embodiments of this application.

The model prediction processing apparatus provided in embodiments of this application can implement the processes implemented in the method embodiments shown in FIG. 3 and FIG. 4, and the same technical effects are achieved. To avoid repetition, details are not described herein again.

As shown in FIG. 7, embodiments of this application further provide a communication device 700, including a processor 701 and a memory 702. The memory 702 stores a program or instructions runnable on the processor 701. The program or the instructions, when executed by the processor 701, implement the steps in the foregoing embodiments of the model prediction processing method, and the same technical effects can be achieved. To avoid repetition, details are not described herein again.

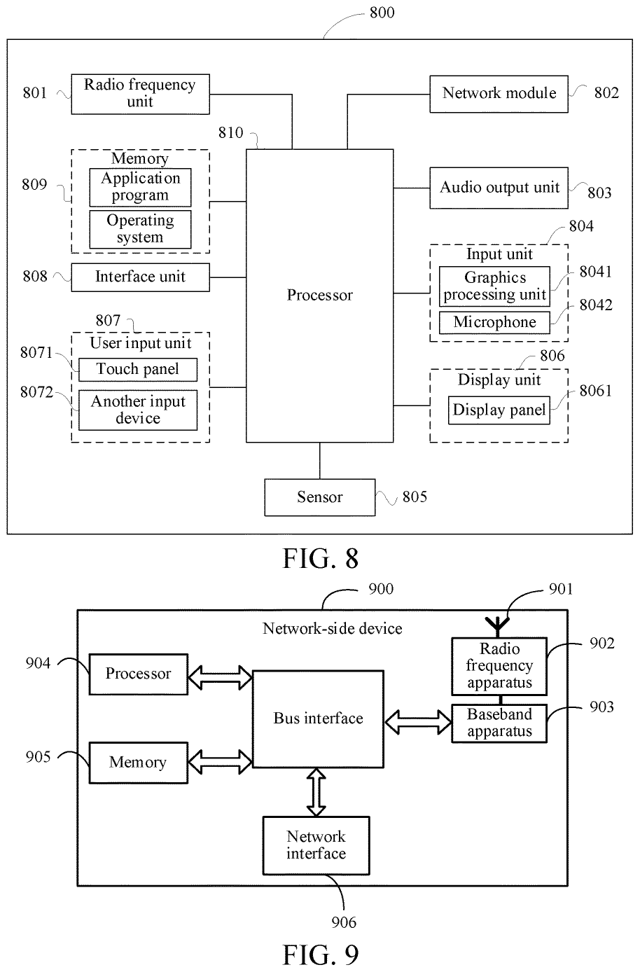

Embodiments of this application further provide a terminal, including a processor and a communication interface. The communication interface is coupled to the processor. The processor is configured to run a program or instructions, to implement the steps in the method embodiment shown in FIG. 3. This terminal embodiment corresponds to the foregoing method embodiments of the terminal side. Implementation processes and implementations of the foregoing method embodiments all may be applied to this terminal embodiment, and the same technical effects can be achieved. Specifically, FIG. 8 is a diagram of a hardware structure of a terminal according to an embodiment of this application.

A terminal 800 includes, but is not limited to, at least part of components such as a radio frequency unit 801, a network module 802, an audio output unit 803, an input unit 804, a sensor 805, a display unit 806, a user input unit 807, an interface unit 808, a memory 809, and a processor 810.

A person skilled in the art may understand that the terminal 800 may further include a power supply (such as a battery) for supplying power to the components. The power supply may be logically connected to the processor 810 via a power management system, thereby implementing functions such as charging, discharging, and power consumption management through the power management system. The terminal structure shown in FIG. 8 constitutes no limitation on the terminal. The terminal may include more or fewer components than those shown in the figure, or some component are combined, or a different component deployment is used. Details are not described herein again.

It should be understood that, in embodiments of this application, the input unit 804 may include a graphics processing unit (GPU) 8041 and a microphone 8042. The graphics processing unit 8041 performs processing on image data of a static picture or a video that is obtained by an image obtaining apparatus (such as a camera) in a video obtaining mode or an image obtaining mode. The display unit 806 may include a display panel 8061, which may be configured in the form of a liquid crystal display, an organic light-emitting diode, or the like. The user input unit 807 includes at least one of a touch panel 8071 and another input device 8072. The touch panel 8071 is also referred to as a touchscreen. The touch panel 8071 may include two parts: a touch detection apparatus and a touch controller. The another input device 8072 may include, but is not limited to, a physical keyboard, a functional button (such as a volume control button or a switch button), a track ball, a mouse, or a joystick. Details are not described herein again.

In embodiments of this application, after receiving downlink data from a network-side device, the radio frequency unit 801 may transmit the data to the processor 810 for processing. In addition, the radio frequency unit 801 may send uplink data to the network-side device. Generally, the radio frequency unit 801 includes, but is not limited to, an antenna, an amplifier, a transceiver, a coupler, a low noise amplifier, a duplexer, and the like.

The memory 809 may be configured to store a software program or instructions, as well as various data. The memory 809 may primarily include a first storage region for storing a program or instructions and a second storage region for storing data. The first storage region may store an operating system, an application program or instructions required by at least one function (such as a sound playback function or an image playback function), or the like. In addition, the memory 809 may include a volatile memory or a non-volatile memory. The non-volatile memory may be a read-only memory (ROM), a programmable ROM (PROM), an erasable PROM (EPROM), an electrically EPROM (EEPROM) or a flash memory. The volatile memory may be a random access memory (RAM), a static RAM (SRAM), a dynamic RAM (DRAM), a synchronous DRAM (SDRAM), a double data rate SDRAM (DDRSDRAM), an enhanced SDRAM (ESDRAM), a synch link DRAM (SLDRAM), and a direct rambus RAM (DRRAM). The memory 809 in embodiments of this application includes, but is not limited to, these memories and any other memory of a suitable type.

The processor 810 may include one or more processing units. Optionally, the processor 810 integrates an application processor and a modem processor. The application processor primarily processes operations related to an operating system, a user interface, an application program, and the like. The modem processor primarily processes a radio communication signal, such as a baseband processor. It may be understood that the modem processor may not be integrated into the processor 810.

The radio frequency unit 801 is configured to receive configuration information from the network-side device, where the configuration information is used for configuring a target artificial intelligence AI model.

The processor 810 is configured to perform model inference based on the target AI model, to obtain a prediction result, where the prediction result includes a first output or a second output of the target AI model.

The first output includes at least one of the following: an indication of whether a target timer will expire; a moment at which the target timer expires; predicted signal quality of a serving cell at a future moment; predicted signal quality of a neighboring cell at the future moment; predicted signal quality of a target cell at the future moment; an indication of whether a first target behavior will occur; and a moment at which the first target behavior occurs.

The second output includes at least one of the following: an indication of whether a target counter will reach a maximum counting value; a moment at which the target counter reaches the maximum counting value; predicted signal quality of a serving cell at a future moment; predicted signal quality of a neighboring cell at the future moment; predicted signal quality of a target cell at the future moment; an indication of whether a second target behavior will occur; and a moment at which the second target behavior occurs.

The first target behavior refers to a behavior corresponding to the target timer expiring, and the second target behavior refers to a behavior corresponding to the target counter reaching the maximum counting value.

It may be understood that the implementation processes of the implementations in this embodiment may refer to the relevant description of the method embodiments of the terminal side, and the same or corresponding technical effects are achieved. To avoid repetition, details are not described herein again.

Embodiments of this application further provide a network-side device, including a processor and a communication interface. The communication interface is coupled to the processor, and the processor is configured to run a program or instructions, to implement the steps of the method embodiment shown in FIG. 4. This embodiment of the network-side device corresponds to the foregoing method embodiments of the network-side device, and implementation processes and implementations of the foregoing method embodiments can be applied to this embodiment of the network-side device, and the same technical effects can be achieved.

Specifically, embodiments of this application further provide a network-side device. As shown in FIG. 9, a network-side device 900 includes: an antenna 901, a radio frequency apparatus 902, a baseband apparatus 903, a processor 904, and a memory 905. The antenna 901 is connected to the radio frequency apparatus 902. In an uplink direction, the radio frequency apparatus 902 receives information through the antenna 901, and sends the received information to the baseband apparatus 903 for processing. In a downlink direction, the baseband apparatus 903 processes to-be-sent information and send the information to the radio frequency apparatus 902. The radio frequency apparatus 902 processes received information and sends the information through the antenna 901.

The method performed by the network-side device in the foregoing embodiment may be implemented in the baseband apparatus 903, and the baseband apparatus 903 includes a baseband processor.

The baseband apparatus 903 may include, for example, at least one baseband board. A plurality of chips are disposed on the baseband board. As shown in FIG. 9, one chip is, for example, the baseband processor, and is connected to the memory 905 through a bus interface, to invoke a program in the memory 905, and perform network-side device operations shown in foregoing method embodiments.

The network-side device may further include a network interface 906, and the interface is, for example, a common public radio interface (CPRI).

Specifically, the network-side device 900 in embodiments of this application further includes: an instruction or a program stored in the memory 905 and runnable on the processor 904. The processor 904 invokes the instructions or the program in the memory 905 to perform the method performed by the modules shown in FIG. 6, and the same technical effects are achieved. To avoid repetition, details are not described herein again.

Embodiments of this application further provide a readable storage medium. The readable storage medium stores a program or instructions. The program or instructions, when executed by a processor, implement the processes in the foregoing embodiments of the model prediction processing method, and the same technical effects can be achieved. To avoid repetition, details are not described herein again.

The processor is a processor in the terminal in the foregoing embodiments. The readable storage medium includes a computer-readable storage medium, such as a computer read-only memory ROM, a random access memory RAM, a magnetic disk, or an optical disc. In some examples, the readable storage medium may be a non-transitory readable storage medium.

Embodiments of this application further provide a chip. The chip includes a processor and a communication interface. The communication interface is coupled to the processor. The processor is configured to run a program or instructions, to implement the processes in the foregoing embodiments of the model prediction processing method, and the same technical effects can be achieved. To avoid repetition, details are not described herein again.

It should be understood that the chip mentioned in embodiments of this application may alternatively be referred to as a system-level chip, a system chip, a chip system, a system on a chip, or the like.

Embodiments of this application further provide a computer program/program product. The computer program/program product is stored in a storage medium and executed by at least one processor to implement the processes in the foregoing embodiments of the model prediction processing method, and the same technical effects can be achieved. To avoid repetition, details are not described herein again.

Embodiments of this application further provide a wireless communication system, including: a terminal and a network-side device. The terminal may be configured to perform the steps of the model prediction processing method of the terminal side. The network-side device may be configured to perform the steps of the model prediction processing method of the network-side device.

It should be noted that the terms “comprise”, “include” or any other variations thereof herein are intended to cover non-exclusive inclusions, such that a process, method, article, or apparatus including a series of elements not only includes those elements, but also includes other elements that are not explicitly listed, or also includes inherent elements of such a process, method, article, or apparatus. An element preceded by a statement “includes a . . . ” does not, without more constraints, preclude the presence of additional identical elements in the process, method, article, or apparatus that includes the element. In addition, it should be noted that the scope of the method and apparatus in embodiments of this application is not limited to performing functions in an order shown or discussed, and may further include performing functions in a basically simultaneous manner or in a reverse order according to related functions. For example, the described method may be performed in an order different from the described order, and various steps may be added, omitted, or combined. In addition, features described with reference to some examples may be combined in other examples.

According to the descriptions of the foregoing implementations, a person skilled in the art may clearly understand that the method in the foregoing embodiments may be implemented by using a computer software product and a necessary universal hardware platform, or may certainly be implemented by using hardware. The computer software product is stored in a storage medium (such as a ROM, a RAM, a magnetic disk, or an optical disc), and includes several instructions, to enable a terminal or a network-side device to perform the methods described in embodiments of this application.

The foregoing describes embodiments of this application with reference to the accompanying drawings. However, this application is not limited to the foregoing specific implementations. The foregoing specific implementations are merely examples, but are not limitative. Inspired by this application, a person of ordinary skill in the art may further make implementations in many forms without departing from the spirit of this application and the protection scope of the claims, and all the implementations shall fall within the protection of this application.

What is claimed is:

1. A model prediction processing method, comprising:
receiving, by a terminal, configuration information from a network-side device, wherein the configuration information is used for configuring a target artificial intelligence (AI) model; and
performing, by the terminal, model inference based on the target AI model, to obtain a prediction result, wherein the prediction result comprises a first output or a second output of the target AI model;
the first output comprises at least one of the following: an indication of whether a target timer will expire; a moment at which the target timer expires; predicted signal quality of a serving cell at a future moment; predicted signal quality of a neighboring cell at the future moment; predicted signal quality of a target cell at the future moment; an indication of whether a first target behavior will occur; or a moment at which the first target behavior occurs;
the second output comprises at least one of the following: an indication of whether a target counter will reach a maximum counting value; a moment at which the target counter reaches the maximum counting value; predicted signal quality of a serving cell at a future moment; predicted signal quality of a neighboring cell at the future moment; predicted signal quality of a target cell at the future moment; an indication of whether a second target behavior will occur; or a moment at which the second target behavior occurs; and
the first target behavior refers to a behavior corresponding to the target timer expiring, and the second target behavior refers to a behavior corresponding to the target counter reaching the maximum counting value.

2. The method according to claim 1, wherein after the performing, by the terminal, model inference based on the target AI model, to obtain the prediction result, the method further comprises:
performing, by the terminal, an operation corresponding to a target behavior in a case that the prediction result is a first target result, wherein the target behavior comprises the first target behavior or the second target behavior, and the first target result is that the first output indicates that the first target behavior will occur or the second output indicates that the second target behavior will occur; and
continuing, by the terminal, to run the target timer or the target counter in a case that the prediction result is a second target result, wherein the second target result is that the first output indicates that the first target behavior will not occur or the second output indicates that the second target behavior will not occur.

3. The method according to claim 2, wherein the first target result comprises at least one of the following:
an indication that the target timer will expire or an indication that the target counter will reach the maximum counting value;
an indication that the first target behavior will occur or an indication that the second target behavior will occur; or
the moment at which the first target behavior occurs or the moment at which the second target behavior occurs.

4. The method according to claim 1, wherein at least one of the first target behavior or the se cond target behavior comprises at least one of the following: a radio link failure; a beam failure; or a handover failure.

5. The method according to claim 1, wherein after the performing, by the terminal, model inference based on the target AI model, to obtain the prediction result, the method further comprises:
reporting, by the terminal, the prediction result to the network-side device.

6. The method according to claim 1, wherein the performing, by the terminal, model inference based on the target AI model, to obtain the prediction result comprises:
performing, by the terminal, model inference based on the target AI model at a target moment, to obtain the prediction result, wherein the target moment satisfies at least one of the following:
the target moment is a moment at which the target timer is started;
the target moment is located after the moment at which the target timer is started, and the target moment is separated from the moment at which the target timer is started by first preset duration;
the target moment is a moment at which the target counter changes from 0 to 1; or
the target moment is located after the moment at which the target counter changes from 0 to 1, and the target moment is separated from the moment at which the target counter changes from 0 to 1 by second preset duration.

7. The method according to claim 1, wherein the performing, by the terminal, model inference based on the target AI model, to obtain the prediction result comprises:
performing model inference on the target AI model based on a first input or a second input, to obtain the prediction result, wherein
the first input comprises at least one of the following: signal quality of the serving cell at a historical moment before the target timer is started; signal quality of the neighboring cell at the historical moment before the target timer is started; signal quality of the target cell at the historical moment before the target timer is started; signal quality of the serving cell during running of the target timer; signal quality of the neighboring cell during running of the target timer; signal quality of the target cell during running of the target timer; a terminal position at the historical moment before the target timer is started; a terminal velocity at the historical moment before the target timer is started; a terminal direction at the historical moment before the target timer is started; a terminal position during running of the target timer; a terminal velocity during running of the target timer; or a terminal direction during running of the target timer; and
the second input comprises at least one of the following: signal quality of the serving cell during a period in which a counting value of the target counter is non-zero; signal quality of the neighboring cell during the period in which the counting value of the target counter is non-zero; signal quality of the target cell during the period in which the counting value of the target counter is non-zero; signal quality of the serving cell at a historical moment before the counting value of the target counter is 1; signal quality of the neighboring cell at the historical moment before the counting value of the target counter is 1; signal quality of the target cell at the historical moment before the counting value of the target counter is 1; a terminal position during the period in which the counting value of the target counter is non-zero; a terminal velocity during the period in which the counting value of the target counter is non-zero; a terminal direction during the period in which the counting value of the target counter is non-zero; a terminal position at the historical moment before the counting value of the target counter is 1; a terminal velocity at the historical moment before the counting value of the target counter is 1; or a terminal direction at the historical moment before the counting value of the target counter is 1.

8. The method according to claim 1, further comprising:
receiving, by the terminal, target indication information from the network-side device, wherein the target indication information indicates a name of a first object to which the target AI model is applicable or an identifier associated with the first object, and the first object is the target timer or the target counter.

9. The method according to claim 1, wherein before the performing, by the terminal, model inference based on the target AI model, to obtain the prediction result, the method further comprises:
receiving, by the terminal, first signaling from the network-side device, wherein the first signaling indicates at least one of the following:
starting, resuming, or activating an AI model function of the target timer;
starting, resuming, or activating an AI model corresponding to the target timer;
starting, resuming, or activating an AI model function of the target counter;
starting, resuming, or activating an AI model corresponding to the target counter;
starting, resuming, or activating an AI model function of the first target behavior;
starting, resuming, or activating an AI model corresponding to the first target behavior;
starting, resuming, or activating an AI model function of the second target behavior; or
starting, resuming, or activating an AI model corresponding to the second target behavior.

10. The method according to claim 9, wherein before the receiving, by the terminal, the first signaling from the network-side device, the method further comprises:
reporting, by the terminal, capability information to the network-side device, wherein the capability information comprises at least one of the following:
whether an AI model function of a timer is available, or whether an AI model corresponding to the timer is available;
whether an AI model function of a counter is available, or whether an AI model corresponding to the counter is available;
whether an AI model function of a first behavior is available, or whether an AI model corresponding to the first behavior is available, wherein the first behavior refers to a behavior corresponding to the timer expiring; or
whether an AI model function of a second behavior is available, or whether an AI model corresponding to the second behavior is available, wherein the second behavior refers to a behavior corresponding to the counter reaching a maximum counting value.

11. The method according to claim 1, further comprising:
receiving, by the terminal, second signaling from the network-side device, wherein the second signaling indicates at least one of the following: stopping, suspending, or deactivating an AI model function of a second object; stopping, suspending, or deactivating an AI model corresponding to the second object; stopping, suspending, or deactivating the AI model function of the first target behavior, stopping, suspending, or deactivating the AI model corresponding to the first target behavior; stopping, suspending, or deactivating the AI model function of the second target behavior; or stopping, suspending, or deactivating the AI model corresponding to the second target behavior; and
determining, by the terminal based on the second signaling, to stop inference of the AI model corresponding to the second object, wherein the second object comprises at least one of the target timer or the target counter.

12. The method according to claim 1, further comprising:
collecting, by the terminal, target information, wherein the target information is used for performing model training; and
the target information comprises at least one of the following:
first information, wherein the first information comprises at least one of the following: a name of a timer; an identifier associated with the timer; time information corresponding to a starting moment of the timer; time information corresponding to a stopping moment of the timer; time information corresponding to a moment at which the timer expires; signal quality of the serving cell at a historical moment before the timer is started; signal quality of the neighboring cell at the historical moment before the timer is started; signal quality of the target cell at the historical moment before the timer is started; signal quality of the serving cell during running of the timer; signal quality of the neighboring cell during running of the timer; signal quality of the target cell during running of the timer; a terminal position at the historical moment before the timer is started; a terminal velocity at the historical moment before the timer is started; a terminal direction at the historical moment before the timer is started; a terminal position during running of the timer; a terminal velocity during running of the timer; a terminal direction during running of the timer; or a moment at which a first behavior occurs, and the first behavior refers to a behavior corresponding to the timer expiring; or
second information, wherein the second information comprises at least one of the following: a name of a counter; an identifier associated with the counter; time information corresponding to a moment at which 1 is added to a counting value of the counter; time information corresponding to a moment at which the counting value of the counter is reset to 0; time information corresponding to a moment at which the counter reaches a maximum counting value; signal quality of the serving cell during a period in which the counting value of the counter is non-zero; signal quality of the neighboring cell during the period in which the counting value of the counter is non-zero; signal quality of the target cell during the period in which the counting value of the counter is non-zero; signal quality of the serving cell at a historical moment before the counting value of the counter is 1; signal quality of the neighboring cell at the historical moment before the counting value of the counter is 1; signal quality of the target cell at the historical moment before the counting value of the counter is 1; a terminal position during the period in which the counting value of the counter is non-zero; a terminal velocity during the period in which the counting value of the counter is non-zero; a terminal direction during the period in which the counting value of the counter is non-zero; a terminal position at the historical moment before the counting value of the counter is 1; a terminal velocity at the historical moment before the counting value of the counter is 1; a terminal direction at the historical moment before the counting value of the counter is 1; or a moment at which a second behavior occurs, and the second behavior refers to a behavior corresponding to the counter reaching the maximum counting value.

13. A model prediction processing method, comprising:
sending, by a network-side device, configuration information to a terminal, wherein the configuration information is used for configuring a target artificial intelligence (AI) model, the target AI model is configured to perform model inference to obtain a prediction result, and the prediction result comprises a first output or a second output of the target AI model;
the first output comprises at least one of the following: an indication of whether a target timer will expire; a moment at which the target timer expires; predicted signal quality of a serving cell at a future moment; predicted signal quality of a neighboring cell at the future moment; predicted signal quality of a target cell at the future moment; an indication of whether a first target behavior will occur; or a moment at which the first target behavior occurs;
the second output comprises at least one of the following: an indication of whether a target counter will reach a maximum counting value; a moment at which the target counter reaches the maximum counting value; predicted signal quality of a serving cell at a future moment; predicted signal quality of a neighboring cell at the future moment; predicted signal quality of a target cell at the future moment; an indication of whether a second target behavior will occur; or a moment at which the second target behavior occurs; and
the first target behavior refers to a behavior corresponding to the target timer expiring, and the second target behavior refers to a behavior corresponding to the target counter reaching the maximum counting value.

14. The method according to claim 13, wherein at least one of the first target behavior or the second target behavior comprises at least one of the following: a radio link failure; a beam failure; or a handover failure.

15. The method according to claim 13, wherein after the sending, by the network-side device, the configuration information to the terminal, the method further comprises:
receiving, by the network-side device, the prediction result from the terminal.

16. The method according to claim 13, further comprising:
sending, by the network-side device, target indication information to the terminal, wherein the target indication information indicates a name of a first object to which the target AI model is applicable or an identifier associated with the first object, and the first object is the target timer or the target counter.

17. The method according to claim 13, wherein after the sending, by the network-side device, the configuration information to the terminal, the method further comprises:
sending, by the network-side device, first signaling to the terminal, wherein the first signaling indicates at least one of the following:
starting, resuming, or activating an AI model function of the target timer;
starting, resuming, or activating an AI model corresponding to the target timer;
starting, resuming, or activating an AI model function of the target counter;
starting, resuming, or activating an AI model corresponding to the target counter;
starting, resuming, or activating an AI model function of the first target behavior;
starting, resuming, or activating an AI model corresponding to the first target behavior;
starting, resuming, or activating an AI model function of the second target behavior; or
starting, resuming, or activating an AI model corresponding to the second target behavior;
wherein before the sending, by the network-side device, the first signaling to the terminal, the method further comprises:
receiving, by the network-side device, capability information from the terminal, wherein the capability information comprises at least one of the following:
whether an AI model function of a timer is available, or whether an AI model corresponding to the timer is available;
whether an AI model function of a counter is available, or whether an AI model corresponding to the counter is available;
whether an AI model function of a first behavior is available, or whether an AI model corresponding to the first behavior is available, wherein the first behavior refers to a behavior corresponding to the timer expiring; or
whether an AI model function of a second behavior is available, or whether an AI model corresponding to the second behavior is available, wherein the second behavior refers to a behavior corresponding to the counter reaching a maximum counting value.

18. The method according to claim 13, further comprising:
sending, by the network-side device, second signaling to the terminal, wherein the second signaling indicates at least one of the following: stopping, suspending, or deactivating an AI model function of a second object; stopping, suspending, or deactivating an AI model corresponding to the second object; stopping, suspending, or deactivating the AI model function of the first target behavior; stopping, suspending, or deactivating the AI model corresponding to the first target behavior; stopping, suspending, or deactivating the AI model function of the second target behavior; or stopping, suspending, or deactivating the AI model corresponding to the second target behavior; and
the second object comprises at least one of the target timer or the target counter.

19. A terminal, comprising a processor and a memory, wherein the memory stores a program or instructions runnable on the processor, wherein the program or instructions, when executed by the processor, cause the terminal to perform:
receiving configuration information from a network-side device, wherein the configuration information is used for configuring a target artificial intelligence (AI) model; and
performing model inference based on the target AI model, to obtain a prediction result, wherein the prediction result comprises a first output or a second output of the target AI model;
the first output comprises at least one of the following: an indication of whether a target timer will expire; a moment at which the target timer expires; predicted signal quality of a serving cell at a future moment; predicted signal quality of a neighboring cell at the future moment; predicted signal quality of a target cell at the future moment; an indication of whether a first target behavior will occur; or a moment at which the first target behavior occurs;
the second output comprises at least one of the following: an indication of whether a target counter will reach a maximum counting value; a moment at which the target counter reaches the maximum counting value; predicted signal quality of a serving cell at a future moment; predicted signal quality of a neighboring cell at the future moment; predicted signal quality of a target cell at the future moment; an indication of whether a second target behavior will occur; or a moment at which the second target behavior occurs; and
the first target behavior refers to a behavior corresponding to the target timer expiring, and the second target behavior refers to a behavior corresponding to the target counter reaching the maximum counting value.

20. A network-side device, comprising a processor and a memory, wherein the memory stores a program or instructions runnable on the processor, and the program or instructions, when executed by the processor, implement the steps of the model prediction processing method according to claim 13.
